(19) United States
(12) Patent Application Publication
(10) Pub. No.: US 2017/0114779 A1
(43) Pub. Date: Apr. 27, 2017

(54) LIQUID-COOLED ELECTRICAL APPARATUS

(71) Applicant: VESTAS WIND SYSTEMS A/S, Aarhus N (DK)

(72) Inventor: Tusitha ABEYASEKERA, Aarhus N (DK)

(21) Appl. No.: 15/129,193

(22) PCT Filed: Mar. 19, 2015
(86) PCT No.: PCT/DK2015/050056

§ 371 Date: Sep. 26, 2016

(30) Foreign Application Priority Data
Mar. 25, 2014 (DK) PA 2014 70149

(51) Int. Cl. F03D 80/60; H02K 9/193; H01F 27/10; F03D 9/00

(52) U.S. Cl. CPC F03D 80/60; F03D 9/002; H02K 9/193; H01F 27/10

(57) ABSTRACT

An inductor 1 for connecting a wind turbine generator to the electricity grid is mounted within a housing 2, and the coils of the inductor 1 are cooled by means of cooling plates 3 located within the coils, and in which are formed tubular conduits. Coolant liquid is supplied to the conduits through supply pipes 7 which are connected to the conduits by means of connectors 8 mounted underneath the housing 2 , such that any coolant liquid which escapes from the connectors 8 falls under gravity into a drip tray 10 arranged below the housing 2. Corresponding connectors are provided underneath the housing for connecting the conduits to outflow pipes. A sensor 11 within the drip tray 10 detects the presence of any coolant liquid which has leaked from the connectors 8 and, in response, generates an alarm signal which is transmitted to control circuitry for disconnecting the inductor 1 and shutting down the wind turbine generator.

The present invention relates to electrical apparatus which is cooled using liquid, and in particular to the cooling of inductors within electrical converters for use with wind turbine generators.

An inductor is typically connected between a wind turbine generator converter and the electricity grid to satisfy grid code requirements regarding power quality. The high power levels typically encountered within the relatively small volume occupied by such an inductor generate significant heat, giving rise to a requirement for a suitable cooling system. There are significant design constraints which would preclude the use of forced air cooling, and therefore liquid cooling is conventionally employed.

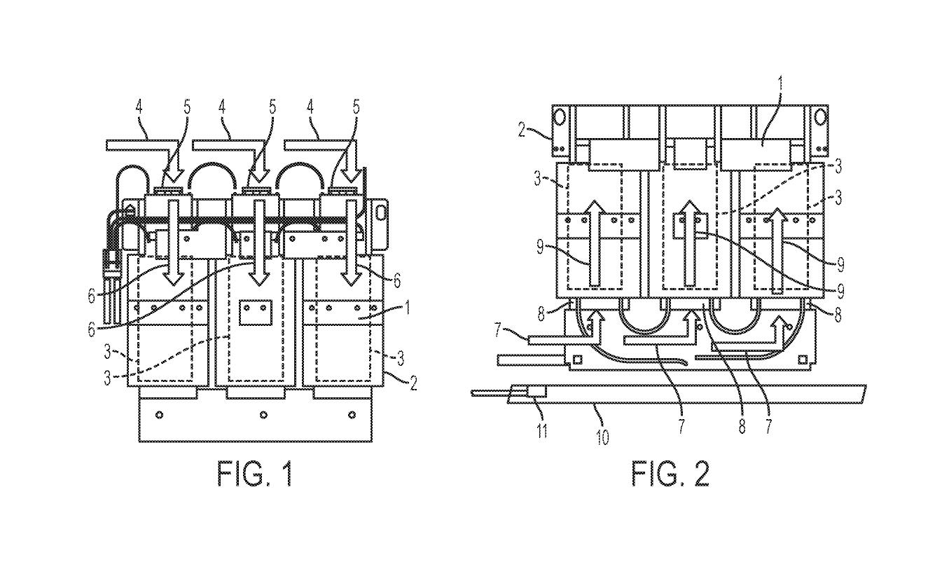

Such a system is illustrated schematically in FIG. 1, in which an inductor 1 is mounted within a housing 2. The coils of the inductor 1 are cooled by means of cooling plates 3 located within the coils, and in which are formed tubular conduits (not shown). A coolant liquid is supplied to the conduits through supply pipes 4 which are connected to the conduits by means of connectors 5 mounted to the upper surface of the housing 2. The direction of flow of the coolant liquid is indicated by arrows 6. The coolant liquid flows out of the conduits through outflow pipes (not shown), which are likewise connected to the conduits by means of connectors (not shown), again mounted to the upper surface of the housing 2.

One problem with such a system is that, if one of the connectors 5 develops a leak, the coolant liquid will fall under gravity into the housing 2 and can come into direct contact with the windings of the inductor 1. This, in turn, can lead to a loss of reliability of the inductor 1 and possible arcing and electrical short circuits which would create a fire hazard. This is especially the case in high-power inductors used in conjunction with wind turbine generators in which the large amount of copper and other material is susceptible to fire.

Typical inductors installed between wind turbine generators and the electricity grid incorporate a large number of connectors 5, which means that the risk of a leak developing in one of the connectors 5 is significant.

A further disadvantage of such an arrangement is the possibility of air pocket formation within the coolant path, which obstructs the coolant flow, thereby reducing cooling efficiency and over-heating the inductor 1.

It would therefore be desirable to provide arrangements which overcome, or mitigate, one or more of these disadvantages.

Thus, in accordance with a first aspect of the present invention there is provided apparatus comprising a housing containing electrical apparatus, a conduit for coolant liquid arranged within the housing and in thermal contact with the electrical apparatus, and at least one connector located on the underside of the housing for supplying coolant liquid to the conduit.

By arranging the at least one connector on the underside of the housing, any coolant liquid which leaks from the connector will fall under gravity away from the housing and cannot therefore come into contact with the inductor windings.

Furthermore, by causing the coolant liquid to flow in a rising path into the conduit, the formation of air pockets in the conduit is avoided.

An additional advantage of this arrangement is that, as the coolant is heated by the windings of the inductor 1, the coolant is caused to rise within the conduit purely as a result of convection, thereby reducing the external power required to pump the coolant liquid through the conduit.

In a preferred arrangement, the apparatus further comprises at least one connector located on the underside of the housing for removing coolant liquid from the conduit.

The apparatus preferably further comprises means for detecting the presence of coolant liquid which has leaked from the at least one connector. This enables an indication of the leak to be provided to service personnel.

In this case, there is preferably provided a drip tray located below the housing which contains the detecting means. This enables the detecting means to be located at a height within the drip tray which is appropriate for indicating the existence of a leak.

The apparatus preferably comprises means acting in response to the detection of the presence of leaked coolant for disconnecting the electrical apparatus. This provides a safety mechanism which enables the inductor to be shut down in the event of a leak of the coolant liquid.

The present invention is particularly intended to be applied to inductors, in which case the conduit is advantageously arranged within a plate inside the windings of the inductor.

The inductor may be a grid-side inductor of a wind turbine generator.

In accordance with a further aspect of the present invention, there is provided a wind turbine generator comprising a liquid-cooled inductor within a housing, which is arranged to be cooled by means of liquid passing through a conduit within the housing which is in thermal contact with the inductor, wherein the liquid is arranged to be supplied to the conduit via one or more connectors located on the underside of the housing.

In a preferred arrangement, the liquid is arranged to be removed from the conduit via one or more connectors located on the underside of the housing.

The present invention can be applied both to offshore and onshore wind turbine generators, since it would be undesirable in both situations for any coolant liquid to come into contact with the inductor windings.

A preferred embodiment of the present invention will now be described with reference to the accompanying drawings, in which:

FIG. 1 is a schematic representation of a known liquid-cooled inductor; and

FIG. 2 is a schematic representation of a liquid-cooled inductor in accordance with an embodiment of the present invention.

Referring to FIG. 2, which uses the same reference numerals as in FIG. 1 to indicate the same components, an inductor 1 is mounted within a housing 2, and the aluminium coils of the inductor 1, together with the steel core (not shown) of the inductor 1 are cooled by means of aluminium cooling plates 3 located within the coils, and in which are formed tubular conduits (not shown), as with the known arrangement of FIG. 1.

However, in contrast to the arrangement of FIG. 1, the coolant liquid is supplied to the conduits through supply pipes 7 which are connected to the conduits by means of connectors 8 mounted underneath the housing 2. The direction of flow of the coolant liquid is indicated by arrows 9. Corresponding connectors (not shown), also mounted underneath the housing, are connected between the conduits and outflow pipes (not shown).

With this arrangement, any coolant liquid which escapes from the connectors 8 because of a leak falls under gravity.

A drip tray 10 is arranged below the housing 2 to collect any coolant liquid which may have leaked from the connectors 8, and a sensor 11 is provided within the drip tray 10 to detect the presence of liquid which has fallen into the drip tray 10. The sensor 11 generates an alarm signal in the event of a positive detection of liquid, and this is transmitted to control circuitry (not shown) which disconnects the inductor 1 from the wind turbine generator and also shuts down the generator, so that the leak can be rectified by serviced personnel.

Although the present invention has been described with reference to a preferred embodiment, it will be apparent that numerous modifications and variations may be made without departing from the scope of the invention which is defined solely by the following claims.

What is claimed is:

1. Apparatus comprising a housing containing an electrical apparatus, a conduit for coolant liquid arranged within the housing and in thermal contact with the electrical apparatus, and at least one connector located on the underside of the housing for supplying coolant liquid to the conduit.

2. Apparatus as claimed in claim 1, further comprising at least one connector located on the underside of the housing for removing coolant liquid from the conduit.

3. Apparatus as claimed in claim 1, further comprising a detector detecting the presence of coolant liquid which has leaked from the at least one connector.

4. Apparatus as claimed in claim 3, further comprising a drip tray located below the housing which contains the detector.

5. Apparatus as claimed in claim 3, further comprising means acting in response to the detection of the presence of leaked coolant liquid for disconnecting the electrical apparatus.

6. Apparatus as claimed in claim 1, wherein the electrical apparatus is an inductor and the conduit is arranged within a plate inside the windings of the inductor.

7. Apparatus as claimed in claim 6, wherein the inductor is a grid-side inductor of a wind turbine generator.

8. (canceled)

9. A wind turbine generator as claimed in claim 8, wherein the liquid is arranged to be removed from the conduit via one or more connectors located on the underside of the housing.

10. (canceled)

11. (canceled)

12. A wind turbine generator, comprising:
a wind turbine generator housing;
a liquid cooled inductor located within the housing;
a conduit in thermal contact with the liquid cooled inductor, and coupled to one or more connectors located on the underside of the housing; wherein the liquid cooled inductor is arranged to be cooled by means of liquid passing through the conduit, wherein the liquid is arranged to be supplied to the conduit via the one or more connectors.
